(19) United States
(12) Patent Application Publication
(10) Pub. No.: US 2002/0092923 A1
(43) Pub. Date: Jul. 18, 2002

(54) Spraying method and a spray system for coating liquids

(76) Inventor: Ronald Steiger, Gross-Zimmern (DE)

Correspondence Address: LOWE HAUPTMAN GILMAN & BERNER, LLP, Suite 310, 1700 Diagonal Road, Alexandria, VA, 22314, US

(21) Appl. No.: 10/042,395

(22) Filed: Jan. 11, 2002

(30) Foreign Application Priority Data
Jan. 13, 2001 (DE) 101 01 369.8

(51) Int. Cl. B05C 1/00

(52) U.S. Cl. 239/128

(57) ABSTRACT

Cooling gas is fed through a cooling-gas line (14) to a liquid atomizer, preferably an atomizing bell (4) in order to cool its end surface (24) configured underneath streaming coating liquid and therefore in contact with the ambient air. The cooling reduces coating deposition at this end surface or reduces the rate of layering.

The present invention relates to a spraying method and a spray system defined in the preamble of claim 1 and claim 6 resp.

Such spraying methods and spray systems are known in practice.

Bell-shaped rotary atomizers in the form of a bell which atomize and spray a coating liquid on an object to be coated are known from the U.S. Pat. Nos. 4,275,838 and 4,505,430 and from the German patent documents 30 00 002 A1 and 35 09 874 A1. These documents disclose applying a high voltage, which may be negative or positive, to the rotary atomizers and/or the spray coating liquid. The high voltage typically is between 4kv and 140 kv. A high voltage spray system fitted with an irrotational spray nozzle is known from the U.S. Pat. No. 3,731,145.

A coating liquid may cure if exposed to air (oxygen). Volatile ingredients of the coating liquid, in particular solvents in lacquers/enamels and water in water soluble lacquers/enamels shall evaporate the faster the warmer their ambience. Liquid particles cast away from the coating liquid's spray jet deposit on the surfaces of the spray system where they will cure. Moreover curing layers of coating liquid will also materialize on the front side under the flow of coating liquid, or in other designs, on the rotating atomizing bell's or atomizing pane's back side situated under the flow of coating liquid.

The objective of the present invention is to prevent in simple manner the formation of a curing layer of coating liquid on the surfaces of the spray system or at least to reduce the rate of drying of coating liquids on such surfaces.

This goal is attained in the invention by means of the features resp. of claims 1 and 6.

Accordingly the invention relates to a coating-liquid spraying method whereby coating liquid is sprayed from a spray system through a liquid atomizer in the form of an irrotational nozzle or in the form of a rotating rotary atomizing element onto an object to be coated, said method being characterized in that at least one spray-system component on which the coating liquid might deposit and cure shall be cooled by a fluid, cooled coolant which is applied to said component during spray coating in order that cooling said component shall reduce or prevent adhesion and/or the rate of drying and layering of coating liquid on surfaces of said component.

Moreover the invention relates to a liquid-coating spray system containing a liquid atomizer in the form of an irrotational nozzle or in the form of a rotating rotary atomizing element that sprays coating liquid onto an object to be coated, where said system is characterized by a cooling unit cooling a component of the spray system by means of a fluid, cooled coolant during spray coating where coating liquid may deposit on said component and consequently cooling said component shall reduce or prevent adhesion and/or the coating liquid's rate of drying and its layering on surfaces of said component.

Preferably the coolant shall be fed through the cooling unit to the liquid atomizer, especially when latter is a rotary atomizing element in order to cool latter at a surface which is situated in the ambient air and on which flows the coating liquid.

Preferably the coolant shall be a gas, in particular air, that is blown as cooled compressed air onto the surface to be cooled. This step can be implemented by a simple cooling system and by simple coolant lines.

The coolant, ie the gas, is cooled by a cooling system preferably affixed to the spray system or integrated into it. So-called cooling-gas cartridges are especially applicable.

Preferably the cooling unit shall be fitted with a compressed-gas discharge to blow cooled compressed air onto a surface of the component to be cooled, said surface being free of coating liquid and out of reach of it.

The spray system may be kept in part or as a whole at a positive or negative electric potential for instance between 4 kv and 140 kv. The voltage may be constant or variable. Just as in the state of the art, the spray system of the invention may be fitted with one or more of the following compressed-air supplies: “shaping air” which is configured relative to the spray jet and for instance encloses it in bell-shaped manner and flows with it in order to shape it; “bearing air” supporting the rotary atomizing element and/or a turbine driving it; “turbine air” to drive the turbine; “braking air” to decelerate the turbine and the rotary atomizing element. Each of such “air” may be cooled by the cooling unit and in turn be used as a coolant in the spray system in order to cool the spray system or some of its components.

The coating liquid may contain solvents or be water-dilutable, in particular it may be paint, for instance colored or clear lacquer/enamel.

The rotary atomizing element usually assumes a bell shape and is also known as “aerobell” or a pane shape (also known as “turbodisk”) and may rotate at up to 60,000 rpm.

The invention is elucidated below in relation to a preferred embodiment and to the attached drawings.

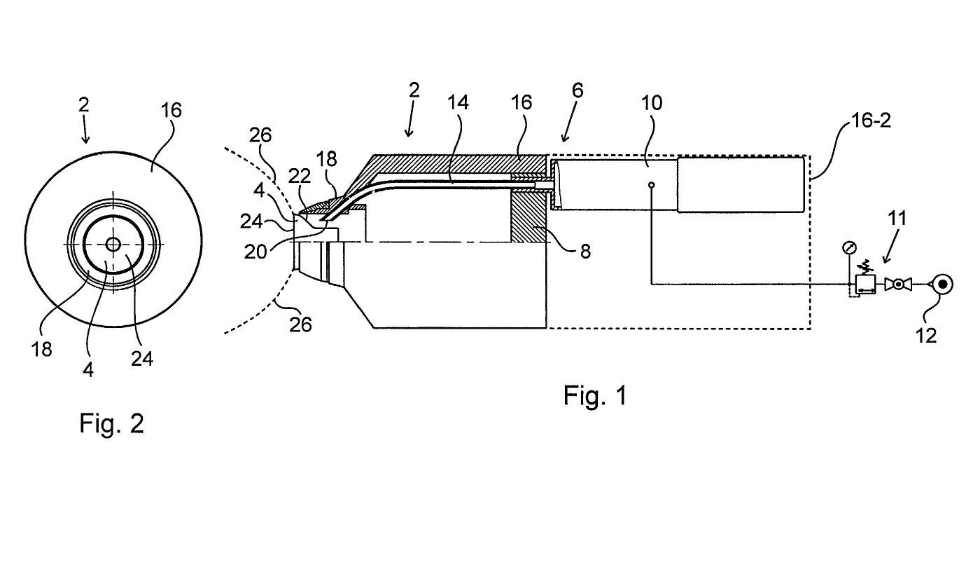

FIG. 1 is a schematic sideview, partly in longitudinal section, of a spray system of the invention, and

FIG. 2 is a front view from the left of the spray system of FIG. 1.

The spray system 2 of the invention shown in the drawings contains a rotating atomizing bell 4 driven by an omitted gas turbine and used to atomize coating liquid.

A cooling unit 6 comprises a cooling element 10 which is affixed to the rear end 8 of the spray system 2 and illustratively contains a so-called cooling cartridge to cool compressed gas, for instance compressed air, from a compressed-gas source 12. The compressed gas cooled by the cooling element 10 flows through a line 14 running inside a spray system housing 16 and through an annular hood 18 at the front end of the spray system end. The compressed gas is guided in metered or controlled manner by a metering or control system 11 from the compressed-gas source 12 through the cooling element 10 where it is cooled and thereupon it is guided through the cooling-gas line 14 and next it is blown through the line discharge 20 onto the external peripheral surface 22 of the atomizing bell 4. The cold of the cooled compressed gas passes through the atomizing bell 4 and in the process cools also latter's front side 24 by means of which the coating liquid is expelled radially outward on account of the centrifugal force of the rotating atomizing bell 4 and flung obliquely forward in the form of a liquid spray jet 26.

The cooling-gas line 12 may be fitted with several line discharges 20 distributed along the external periphery of the atomizing bell 4. The line discharge(s) 20 may assume the shape of round or polygonal apertures or of slit nozzle(s).

The coating liquid is fed through a central liquid feed line to the atomizing bell 4 in the manner of the state of the art.

The system housing 16 may run as shown in a dashed line 16-2 in FIG. 1 around the cooling element 10 and thereby integrate the cooling element 10 into the spray system 2.

1. A method for spraying coating liquids, whereby coating liquid is sprayed from a spray system through a liquid atomizer in the form of an irrotational nozzle or in the form or a rotary atomizing element onto an object to be coated,
characterized in that
at least one component (4) of the spray system (2), where the coating liquid may deposit on said component and cure on it, shall be cooled by a fluid, cooled coolant that is fed to said component during spray coating in order that the cooling of this component (4) shall reduce or prevent the adhesion and/or the drying rate and the layering of coating liquid on a surface (24) of said component.

2. Spraying method as claimed in claim 1, characterized in that the coolant is fed to the liquid atomizer, in particular when latter is a rotary atomizing element (4) in order to cool a surface (24) at said atomizer, where said surface is in ambient air and under the stream of liquid coating.

3. Spraying method as claimed in either of claims 1 and 2, characterized in that a compressed gas, preferably compressed air, is used as the coolant.

4. Spraying method as claimed in claim 3, characterized in that the compressed gas is blown onto a surface (22) of the component (4) to be cooled, where the coating liquid does not stream over said surface.

5. Spraying method as claimed in one of the above claims, characterized in that the coolant is cooled by a cooling element (10) situated at or in the spray system (2).

6. A spray system for coating liquids, comprising a liquid atomizer in the form of an irrotational nozzle or in the form of a rotating rotary atomizing element (4) to spray the coating liquid onto an object to be coated,
characterized by
a cooling unit (6) cooling a component (4) of the spray system (2) by means of a fluid, cooled coolant during spray coating, where there is danger regarding said component (4) that coating liquid may deposit and cure on it, the cooling of said component (4) reducing or preventing both the coating liquid's adhesion to and/or the drying rate on and its layering on a surface of this component (4).

7. Spray system as claimed in claim 6, characterized in that the coolant can be fed by the cooling unit (6) to the liquid atomizer (4) in particular when latter is a rotary atomizing element in order to cool an atomizer surface (24) which is situated in ambient air and underneath the streaming coating liquid.

8. Spray system as claimed in either of claims 6 and 7, characterized in that the coolant is a compressed gas, preferably compressed air.

9. Spray system as claimed in claim 8, characterized in that the cooling unit is fitted with a compressed-gas discharge (20) to blow cooled compressed gas onto a surface (22) of the component (4) to be cooled, where the coating liquid does not stream over said surface.

10. Spray system as claimed in one of claims 6 through 9, characterized in that it comprises a cooling element (10) of the cooling unit (6) to cool the coolant, where said element is configured at the spray system (2) or is integrated into it.
